(19) United States
(12) Patent Application Publication
(10) Pub. No.: US 2009/0062407 A1
(43) Pub. Date: Mar. 5, 2009

(54) METHOD AND APPARATUS FOR PRODUCING MICRO EMULSIONS

(75) Inventors: Steen Brummerstedt Iversen, Vedbaek (DK); Tommy Larsen, Slagelse (DK); Viggo Luthje, Bagsvaerd (DK); Karsten Felsvang, Allerod (DK); Eduard Lack, Wiener Neustadt (AT)

Correspondence Address: KNOBBE MARTENS OLSON & BEAR LLP, 2040 MAIN STREET, FOURTEENTH FLOOR, IRVINE, CA, 92614, US

(73) Assignee: SCF TECHNOLOGIES A/S, Valby (DK)

(21) Appl. No.: 10/586,979

(22) PCT Filed: Jan. 21, 2005
(86) PCT No.: PCT/DK2005/000036

§ 371 Date: Jul. 8, 2008

(30) Foreign Application Priority Data
Jan. 22, 2004 (DK) PA-2004-00083

(51) Int. Cl. B01F 3/04

(52) U.S. Cl. 516/10

(57) ABSTRACT

This invention relates to preparation of micro emulsions having a controlled size. It provides methods, measures, apparatus and products produced by the methods. The method is particularly suitable for preparing micro emulsions of water containing one or more ionic species in an oil and/or dense fluid phase such as CO₂ containing fluids under near or supercritical conditions, thereby enabling the use of said dense fluids as solvents for extraction of ionic species, as nano-reactor templates and/or as a carrier for further processing such as deposition on a solid material and/or in a process for producing fine particles, such as particles in the nano- or micrometer range.

### FIELD OF INVENTION

This invention relates to preparation of micro emulsions having a controlled size. It provides methods, measures, apparatus and products produced by the methods. The method is particularly suitable for preparing micro emulsions of water containing one or more ionic species in an oil and/or dense fluid phase such as CO₂ containing fluids under near or supercritical conditions, thereby enabling the use of said dense fluids as solvents for extraction of ionic species, nano-reactor templates and/or a carrier for further processing such as deposition on a solid material and/or in a process for producing fine particles, such as particles in the nano- or micrometer range.

### BACKGROUND

There is an increasing interest in nano- and micron sized materials in numerous technical applications. Such nanostructured materials in the form of nanocrystalline films and powders are cornerstones in the attempt to develop and exploit nanotechnology, they exhibits properties, which are significantly different from those of the same materials of larger size. During the last decade the insight into nanostructured materials have dramatically improved through the application of new experimental methods for characterization of materials on the nanoscale. This has resulted in the synthesis of unique new materials with unprecedented properties. For nanostructured coatings, physical properties such as elastic modulus, strength, hardness, ductility, diffusivity and thermal expansion coefficient can be manipulated based on nanometer control of the primary particle or grain size. For nanostructured powders, parameters such as the surface area, solubility, electronic structure and thermal conductivity are uniquely size dependent.

The novel properties of such nanostructured materials can be exploited and numerous new applications developed by using them in different industries. Examples of potential applications include new materials such as improved thermoelectric materials, electronics, coatings, semiconductors, memory devices, high temperature superconductors, optical fibres, optical barriers, photographic materials, organic crystals, magnetic materials, shape changing alloys, polymers, conducting polymers, ceramics, catalysts, electronics, paints, coatings, lubricants, pesticides, thin films, composite materials, foods, food additives, antimicrobials, sunscreens, solar cells, cosmetics, drug delivery systems for controlled release and targeting, etc.

Addressing and exploiting such promising applications with new materials generally requires an improved price-performance ratio for the production of nanostructured materials. The key parameters determining the performance are the primary particle size (grain size), size distribution of the primary particles, chemical composition and chemical purity as well as the morphology, shape and surface area of the powders, while the primary parameters in relation to price are the ease of processing and suitability for mass production.

Various techniques have been invented or modified for the manufacture of micron- or nano-sized particles. Conventional techniques include spray drying, freeze drying, milling and fluid grinding, which are capable of producing particles in the micrometer range. Manufacturing techniques for producing submicron materials include high temperature vapour phase techniques, which allow production of nano-scaled powders consisting of hard or soft agglomerates of primary particles. The precursor material of interest is typically evaporated using a flame, resistance, electron beam, laser or electric arc. The evaporated atoms are rapidly cooled under conditions that result in condensation of nanometer sized clusters. Higher evaporation rates leads to higher yields of nanoparticles, but generally also to larger primary particles.

Wet chemistry synthesis methods such as chemical precipitation, hydrothermal and sol-gel synthesis are the major low temperature processes for production of nanomaterials with nano-scaled primary particles or grains. Such basic synthesis techniques is based on chemical precipitation of particles from chemical solutions e.g. by creation of a new phase in a chemical reaction or by super saturation of a soluble phase.

Most homogeneous precipitation techniques to produce nano-scaled particles utilize aqueous salt chemistry. Typically such approaches involve subjecting a metal salt solution to a reactant such as a reducing agent to precipitate fine particles. A spontaneous chemistry and low solubility of the product in the solvent is required to limit the diffusional growth of the particles after precipitation, whereas the physical conditions such as the concentration of the reactants also affects the nuclei number density and the growth of particles after precipitation.

Hydrothermal synthesis may be used for synthesis of a wide range of fine oxide powders. The term hydrothermal relates to the use of water as reaction medium and regime of high pressure and the low to medium temperatures applied. Metal precursors are decomposed to produce fine particles. A major drawback is the relatively long reaction time required at low to medium temperatures and the very corrosive environment at higher temperatures. The nano-scaled particles synthesized are in the form of a liquid suspension.

Sol-gel processing is widely used as it is a versatile technology that allows production of homogeneous high purity fine particles with relatively small primary particles in the form of powders, fibres, spheres, monoliths, aerogels, xerogels as well as coatings and films. The precursor for the reaction may be a metal salt or a metal alkoxide, and the reaction involves a hydrolysis followed by gelation (polycondensation). The reaction often occurs in the presence of an acid or a base. The reaction rates and the specific phase being synthesized depend on parameters such as temperature, pH and the concentrations of the starting materials. Nanoparticles in the form of mixed metal oxides may be synthesized by combining sols of different materials or by co-hydrolyzing/copolymerizing mixtures of alkoxides. The resulting gel is subsequently dried, and calcined or sintered to convert the hydroxylated oxide to the final oxide product.

The key drawbacks from the sol-gel process are that it is time consuming, and need after treatment such as drying and calcinations. In the conventional sol-gel process it is necessary to calcine the product for up to 24 hours in order to obtain a crystalline product. In a addition to a higher energy usage and more complicated process it has the unfortunate effect that substantial growth of primary particles occur, and that the specific surface area may decrease by up to 80%.

### Supercritical Fluids

Supercritical fluids exhibit particular attractive properties such as gas-like mass transfer properties such as diffusivity, viscosity and surface tension, yet having liquid-like properties such as salvation capability and density. Furthermore, the solubility can be manipulated by simple means such as pressure and temperature. Thus, selective dissolution of certain groups of solutes in a supercritical fluid may be achieved by optimising density of the fluid phase. This tuneable solvation capability is a unique property that makes supercritical fluids different from conventional liquids. Another major advantage of supercritical fluid extraction is rapid separation of solutes that can be easily achieved by reduction of pressure.

These attractive properties of such fluids at near or at supercritical conditions have attracted considerable attention for its potential applications as environmentally friendly solvents for chemical processing. Many applications are under development in research laboratories all over the world. Examples include dry cleaning, impregnation (coating), extraction, reaction, synthesis of sub-micron particles, synthesis of advanced materials etc. Carbon dioxide (CO₂) is the most widely fluid used for dense fluid applications because of its moderate critical constants (T_{c}=31.1° C., P_{c} 72.8 atm, and φ_{c}=0.47 g/cm3), non-toxic nature, low cost, and availability in pure form.

Supercritical CO₂ may today be considered as a mature technology for extraction applications such as decaffeination of coffee and tea, extraction of hops, spices, herbs and other natural products. More recently supercritical fluids have been applied for commercial applications within impregnation.

Though many CO₂ applications have been developed or are under development, high pressure CO₂ also exhibits some limitations. Since CO₂ is non-polar and has weak Van der Waal forces, both polar and non-polar non-volatile molecules often exhibits limited solubility or are virtually insoluble. For example, insoluble compounds such as electrolytes, bio molecules, polymers and inorganic compounds can not be directly processed in high pressure CO₂.

The solubility of some of these classes of materials has been improved to some extent by applying co-solvents and/or surfactants in a mixture with CO₂ e.g. metals ions bound to organic ligands such as chelates becomes quite soluble in dense phase CO₂.

Production of micron and submicron sized powders by supercritical techniques have been a hot scientific topic since the beginning of the nineties. The development has particularly been focused on physical transformation processes. They are generally variations of two primary methods for particle precipitation in supercritical fluids, the Solvent-AntiSolvent technique (SAS) and the Rapid Expansion of Supercritical Solutions technique (RESS).

### SAS Technique

In the SAS technique, the material of interest is first dissolved in a suitable organic solvent, and the solution is subsequently mixed with a supercritical solvent, which dissolves the solvent and precipitates the solids out as fine particles.

### RESS Technique

In the RESS technique, the solid of interest is first solubilized in a supercritical fluid and thereafter expanded by spraying through a nozzle. The expansion through the nozzle causes a dramatic reduction in the CO₂ density and thereby a dramatic reduction in the solvent capacity, causing high super saturation resulting in the formation of fine particles.

Derived techniques from the SAS and RESS techniques are for example Solution Enhanced Dispersion by Supercritical Fluids Techniques (SEDS) and Precipitation with Compressed Antisolvent technique (PCA), which is based on the concept of coupling the use of a supercritical fluid as a dispersing agent, by means of a coaxial nozzle, in addition to its primary role as an antisolvent and a vehicle to extract the solvent. Further extensions of this technique include multi concentric opening nozzles.

Other techniques include Precipitation from Gas-Saturated Solutions (PGSS), which involves melting the material to be processed, and subsequently dissolving a supercritical fluid under pressure. The saturated solution is then expanded across a nozzle, where the supercritical fluid, which is more volatile escape leaving dry fine particles.

All these techniques have been successfully used in small scale to produce micron sized particles of various materials for numerous applications. Excellent reviews of prior art supercritical particle formation processes can be found in e.g. Ya-Ping Sun (“Supercritical Fluid Technology in Materials Science and Engineering—Syntheses, Properties and Applications, Marcel Dekker Inc., 2002-ISBN: 0-8247-0651-X), Gentile et al (WO03/035673A1), Gupta et al (US2002/0000681A1), Mazen et al (EP0706421B1), Del Re et al (WO02/068107A2), Mazen et al (WO99/44733), Calfors et al, Jagannathan et al (WO03/053561), all of which are hereby included by reference.

However, all these techniques suffer from some inherent limitations. The RESS technique is limited by the solvent capacity in the supercritical fluid. For example, supercritical carbon dioxide, which is a preferred solvent in many applications, is limited by a low solubility of towards polar substances. Modifiers such as co-solvents and surfactants may be added to the supercritical carbon dioxide to improve the solubility of the material of interest. Drawbacks of the RESS technique includes that isenthalpic expansion over the nozzle results in large temperature drops, which can cause freezing of the solid and carbon dioxide and thereby cause blocking of the nozzle. The nozzle design is further critical for the final particle characteristics such as size and morphology etc. All these drawbacks from microscopic variables limit the control over the process itself, and make scale up difficult.

Due to its higher solubility the SAS technique and its derivatives generally have higher through puts, and it generally produces particles in the range 1-10 micron (Gupta et al, US2002/0000681A1). The key and particle size controlling step of the SAS techniques is the mass transfer rate of the antisolvent into the droplet. Hence, mixing of solution and the supercritical fluid is crucial in order to obtain an intimate and rapid mixing, a dispersion of solution as small droplets into the supercritical fluid is required. Various nozzle designs have been proposed to inject solution and supercritical fluid into a particle formation vessel in order to provide a good mixing. Recent modifications of the SAS technique to reduce the particle size includes atomisation techniques such as special designed coaxial nozzles, vibrational atomisation, atomisation by high frequency sound waves, ultrasonic atomisation etc. (US20020000681A1). Though these modified techniques are believed to provide enhanced mass transfer and to result in reduced particle sizes, too rapid particle formation may reduce the control of the size and morphology such as crystallinity of the formed particles, be sensitive to the nozzle design and blockages of the nozzle and be difficult to scale-up.

A more recent development and versatile method for production of fine particles involves the use of micellar structures as templates or nano-reactors. Micellar structures or emulsions are among the most frequently found colloidal systems, largely present in foods, cosmetics, pharmaceuticals, oils processing, paints etc. They are colloidal dispersion of at least two immiscible fluids. The structure of the emulsions consists of droplets of a dispersed phase in a continuous phase. Typically such micelles are formed using surfactants to reduce the interfacial tension and stabilize the micelles. Such surfactants are amphiphilic molecules containing both a hydrophilic and a lipophilic segment. In normal micelles the continuous phase is an aqueous and the lipophilic segment is arranged to interact with an organic phase. The opposite structures are called reverse micelles, and may be water-in-oil emulsions or water-in-CO₂ emulsions.

Such reverse micelles and micro emulsions allow highly polar or polarizable compounds to be dispersed in this non-polar fluid. A wide range of nanomaterials can now be synthesized using ionic species or water soluble compounds as starting materials in the water cores of the micro emulsions. In these micro emulsion systems, the content of different micellar cavities undergo exchange when the micelles collide, creating opportunities for mixing and reactions between the reactants in the in the different cavities. Examples of applications of such systems are given in e.g. K P Johnson et al, “Water-in Carbon Dioxide micro emulsions: an environment of hydrophiles including proteins”, Science: 271: 624-626, 1996, M. Ji et al: Synthesizing and dispersing silver nanoparticles in a water in super critical carbon dioxide micro emulsion, J. Am. Chem. Soc. 121: 2631-2632, 1999, H. Ohde et al: Synthesizing silver halide nanoparticles in supercritical carbon dioxide CO₂ utilizing a water-in-CO₂ micro emulsion), hereby included by reference. Other uses of such micro emulsions can be found in K. A. Barscherer et al, “Micro emulsions in compressible fluids—a review”, Phase Equilibria 107:93-150, 1995. The water-in-CO₂ micro emulsions may also be used as a medium for conducting electrochemistry in dense fluids (Ya-Ping Sun, Supercritical Fluid Technology in Materials Science and Engineering—Synthesis, Properties and Applications”, Marcel Dekker, Inc., New York 2002, ISBN 0-8247-0651-X). Other applications include protein extraction, biocatalysis, dispersion polymerisation, emulsion polymerisation, metals extraction, dry cleaning, nanoparticle formation.

A number of advantages associated with the supercritical fluids-based emulsion methods can be envisaged. For example the tuneable properties of supercritical fluids through pressure and/or temperature changes will provide more possibilities to manipulate the nanoparticles produced. For potential applications the preparation of nanoparticles in situ in a supercritical fluid system may be coupled with other processes, such as rapid expansion for nanoscale coating and patterning. Another rationale for the use of supercritical fluid micro emulsion systems in the production of nanoscale materials is to take advantage of the templating effect associated with the rapid expansion technique (RESS, RESOLV). The supercritical fluid micro emulsions may be expanded e.g. into a liquid containing a reactant for reaction with the reactant contained in the micro emulsion.

Since water and CO₂ are the two most abundant, inexpensive and environmentally compatible solvents, the application of such systems may have tremendous implications. Water-in-CO₂ and CO₂-in-Water micro emulsions under near or supercritical conditions have the ability to function as a universal solvent medium by solubilizing high concentrations of polar, ionic, and nonpolar nonvolatile compounds within the dispersed or continuous water phase.

However, though tremendous opportunities exist in applying such micro emulsions the practical embodiments for are still limited and rather inefficient. A water-in-CO₂ emulsion is typically formed batch wise by adding water, proper surfactants, and electrolytes into a stirred pressure vessel, and compressing the vessel to the desired pressure by adding CO₂ and stirring the vessel in a time sufficient for the micro emulsions to form.

Such methods suffer from several drawbacks. They are generally limited to batch wise operation as the micro emulsions are formed from macro emulsions, which are cut into smaller emulsions until the desired size is obtained. Though formation and breaking of micelles may be controlled to a certain extent by controlling the pressure and temperature, such methods remains rather inefficient and methods improving the size control with a shorter processing time and having less energy consumption are highly desirable.

Hence, an objective of the present invention may be to provide a semi-continuous or continuous method and apparatus for producing micro emulsions of a controllable size.

Another objective of the present invention may be to provide a methods and measures for improving the solubility of species, which exhibits a low solubility and/or are virtually unsoluble in dense phase CO₂, so they can be dispersed and transported in dense phase CO₂.

Still another objective of the present invention may be to provide improved methods and measures for production of micro emulsions of more controllable size and uniformity, e.g. micro emulsions of water-in-CO₂ or water-in-an organic solvent such as an oil.

A further objective of the present invention may be to provide an improved method for the formation of fine particles with controlled growth rate, particle morphology and crystallinity and a narrow size distribution.

Still another objective of the present invention may be to provide an improved method for producing nano-reactor templates more efficiently and with a more uniform size.

Yet another objective of the present invention may be to provide a method and apparatus for producing a versatile solvent based on micro emulsions enclosed in compressed fluids, thereby enabling the use of said fluids for extraction of polar, ionic, and non-polar non-volatile species in high concentrations, and/or as a carrier for transporting dissolved or dispersed species for further processing such as deposition on a solid matrix and/or for producing fine particles.

A further objective of the present invention may be to provide a method, which allows reduction of the surfactant concentration and/or the required density for stabilizing said micro emulsions.

A still further objective of the present invention may be to provide a method, which allows mixing of more than one type of emulsion and allows easy and controllable addition or extraction of reactants in a continuous manner.

Furthermore, it is an objective to provide an apparatus for production of materials by the method mentioned above. Additionally, it is an objective to provide a product by the above mentioned method.

These objectives and the advantages will be evident from the following description of the invention and the preferred embodiments.

### DESCRIPTION OF THE INVENTION

The present invention provides a novel way for production of micro emulsions in compressed fluids at near or at supercritical conditions, thereby enabling the use of said micro emulsion containing fluids as:
versatile solvent(s) for extraction of polar, ionic, and/or non-polar non-volatile species in high concentrations and/or
as carrier(s) for transporting dissolved and/or dispersed species for further processing such as deposition on a solid matrix and/or
as templates for producing nano-scaled particles.

Hence, a preferred embodiment according to the present invention involves a method for producing emulsions in dense fluid(s) at a near critical or supercritical state comprising:
introducing a first fluid into a pressurised vessel;
introducing one or more surfactant(s) into said pressurised vessel
introducing a second fluid into said pressurised vessel
promoting formation of emulsions of said second fluid within said fluid present in said pressurised vessel.

In the present description the term near critical is intended to mean a compressed fluid being close its critical temperature and pressure such as a fluid being maximum 20 bars and maximum 20° C. from its critical point. An example of a preferred near critical fluid according to the present invention is liquid CO₂ at a pressure of 60 bars and 20° C.

Many preferred embodiments according to the present invention further comprises withdrawing in at least part time of said method a fluid stream comprising said micro emulsions suspended, dispersed or dissolved in said fluid being in a near critical or supercritical state.

The promotion of formation of micro emulsions of said second fluid in said first fluid is often performed after introduction of said fluids and surfactant(s) into said pressureised vessel.

Compressed CO₂ is a particularly preferred fluid in many applications of the present invention due to its relatively low critical pressure and temperature, readily availability, inexpensiveness and non-toxic nature. Hence, one of fluids often comprises compressed CO₂ such as CO₂ in a liquid or a supercritical state.

Another important fluid is water or a water mixture comprising one or more substances being dissolved or dispersed therein. Said substances may be substantially insoluble in the compressed CO₂ and may comprise polar molecules and/or polarizable molecules and/or non-polar non-volatile molecules. Other important fluids in relation to the present invention are organic solvents such as an oil.

The compressed CO₂ fluid phase may further comprise one or more co-solvent(s). Suitable co-solvents includes alcohols, water, ethane, ethylene, propane, butane, sulfurhexafluoride, nitrous oxide, chlorotrifluoromethane, monofluoromethane, methanol, ethanol, DMSO, isopropanol, acetone, THF, acetic acid, ethyleneglycol, polyethylenekglycol, n,n-dimethylaniline etc., and mixtures thereof.

The one or more surfactant(s) being introduced into said pressurised vessel is generally added for stabilisation of said micro emulsions being formed. Suitable surfactants generally comprise a CO₂-philic and a CO₂-phobic segment and include chelates, fluoronated surfactants, perfluoroether surfactants, perfluoropolyether surfactants, fluoroetherfluoroacrylate and siloxane surfactants. Particular suitable surfactants may be selected from the group of hydrocarbons and fluorocarbons having a hydrothphilic/lipophilic balance value (HLB) of less than 15, where the HLB value is determined according to the following formula:

HLB=7+sum(hydrophilic group numbers)−sum(lipophilic group numbers).

The amount of said surfactant being selected in an embodiment according to the present invention generally depend on the specific application and the desired stability of the micro emulsions for that application. Factors affecting the optimal include operating pressure and temperature for the specific application, the type of surfactant, the type and the activity of the second fluid, the amount and type of substances dissolved and/or dispersed within said second fluid.

In embodiments wherein said second fluid comprises water or a water mixture the amount of surfactant(s) compared to the amount of water often correspond to a concentration in the range 0.01 to 10 weight % such as a concentration in the 0.05 to 5 weight %, preferably a concentration in the range 0.1 to 3 weight %, and advantageously the amount of surfactant(s) compared to the amount of water may be in the range 0.5 to 2 weight %.

The molar ratio of water to said surfactant(s) may be at least 5:1 such as at least 10:1, preferably a molar ratio may be at least 20:1 such as a molar ratio of at least 30:1, and advantageously a molar ratio of at least 50:1 such as at least 100:1.

In a preferred embodiment the molar ratio of said surfactant(s) to the dissolved or dispersed molecules in said second fluid is/are selected to be at the most 100:1, such as at a molar ratio of at the most 50:1, and preferably the molar ratio is at the most 30:1, such as at the most 10:1.

The pressurised vessel according to the present invention is often operated at a substantially constant pressure. Typically the pressure of at least one of the fluid present within said pressurised vessel is in the range 50-500 bars, preferably in the range 85-500 bars, such as in the range 100-300 bars. The temperature within said pressureised vessel may be in the range 20-500° C., such as 30-450° C., and preferably in the range 35-200° C., and more preferably in the range 40-150° C.

The emulsions being produced according to the present invention are generally micro- or nano-sized emulsions. Micro or nano-sized emulsions in this context is intended to mean emulsions with micellar or reverse micellar structure, wherein the maximum diameter of the core of said micellar or reverse micellar structure is in the micrometer or nanometer scale, respectively.

In many preferred embodiments according to the present invention the diameter of the core(s) of said micro- or nano emulsion(s) is/are at least partly controlled by controlling the density of said fluid(s) present within said pressurised vessel.

Said micro emulsion(s) may comprise a water core(s). Typically the diameter of said water core(s) is/are at the most 5 micron, such as a diameter of at the most 1 micron, preferably a diameter of at the most 500 nm such as a diameter of at the most 250 nm, and more preferably a diameter of said water core(s) of at the most 100 nm such as a diameter of at the most 50 nm, and advantageously the diameter of said water core(s) is/are below 30 nm.

A number of applications according to the present invention involve withdrawing said micro emulsions formed in semi-continuous or continuous manner from said pressureised vessel.

The fluid stream comprising said micro emulsions formed may be withdrawn to an external device, and used to extract and/or dissolve substances from a material present within said external device.

The water core of said micro emulsions being formed may comprise dissolved and/or dispersed species, and said fluid containing said micro emulsions may be used as a carrier for transporting dissolved and/or dispersed species to an external device.

A particular preferred embodiment involve production of two or more micro emulsions of different composition in separate pressurised vessels and combining said fluids containing said micro emulsions in an external device. Said two or more micro emulsions of different composition may preferably be produced using at least two different surfactants. Said surfactants may be designed with electrostatic forces so as to facilitate contact between micelles of different type and to reduce merging of micelles of the same type. Such electrostatic forces may be introduced by including a molecular charge displacement in the lipophilic part of the surfactant(s). Said molecular charge displacement may be obtained by introducing polarity from organic groups selected from halogenated alkyls and/or halogenated aryls and/or aldehydes and/or ketones and/or ethers and/or hetero-cyclic structures containing oxygen, nitrogen and/or sulphur and/or amides and/or mercaptanes.

Many applications according to the present invention involve the use of said micro emulsions produced as nanoreactors for the synthesis of materials having nano-sized primary particles. The term primary particles in this context are intended to mean grains, crystallites, etc. Said primary particles may in an amorphous or crystalline phase or a combination of the two, and may be formed from one or more chemical reactions occurring within said micro emulsions.

Further the micro emulsions may be used for shaping said primary particles into a specific shape, size and/or structure. In many embodiments the average size of nanoparticle material formed is maximum 5000 nm, such as an average size of maximum 500 nm, preferably the average size is maximum 100 nm, and most preferably the average size is maximum 30 nm, such as maximum 15 nm. In a particularly preferred embodiment the average size of said nano particle material formed is in the range 0.1-30 nm such as in the range 1-10 nm. The average diameter in this context refers to the average diameter of the primary particles, and as said primary particles may have an irregular shape, the average diameter in this context shall preferably be interpreted as an equivalent spherical diameter. Various techniques of varying quality exists for determination of the size of nanoscaled particles. For clarity the average diameters above refers to equivalent spherical diameters determined by Small Angle X-ray Scattering (SAXS) by applying the Beaucage model [G. Beaucage et al, Journal of Noncrystalline Solids 172-174, p. 797-805, 1994]. The Beaucage model is fitted to a specific shape of the particles formed and it is recommended that the shape is checked by a suitable microscopic technique such as Transmission Electron Microscopy (TEM) or Scanning Electron Microscopy (SEM) for consistency.

The synthesis of said nanomaterials may in many preferred embodiments of the present invention be at least partly controlled by controlling the temperature and/or the pressure of the fluid(s) during said synthesis within said micro emulsions.

A preferred embodiment comprises re-circulating in at least part time of the method at least part of a fluid or fluid mixture present in said pressurized vessel, the re-circulating comprising withdrawing from the vessel at least part of the fluid contained in said vessel and feeding it to a re-circulation loop and subsequently feeding it back to said vessel. The re-circulation loop may further comprise the step of controlling the temperature of the fluid in said re-circulation loop.

The fluid volume being withdrawn from said vessel to said re-circulation loop may be relatively large and may correspond to exchange of at least 0.1 vessel volumes per minute such as at least 0.25 vessel volumes per minute, preferably the fluid volume corresponds to exchange of at least 0.5 vessel volumes per minute, and even more preferably it corresponds to exchange of at least 1 vessel volume per minute and advantageously the fluid volume being withdrawn corresponds to exchange of at least 2 vessel volumes per minute such as at least 5 vessel volumes per minute.

The re-circulation loop may further comprise at least one mixing zone for promoting formation of micro emulsion(s). The second fluid and/or said one or more surfactant(s) may in some preferred embodiments be at least partly introduced into at least one of said one or more mixing zone(s) present in the re-circulation loop. In a preferred embodiment said second fluid and said one or more surfactants are pre-mixed prior to being introduced. Said one or more mixing zone(s) may further comprise a static mixer.

In a particularly preferred embodiment for many applications said re-circulation loop may further comprise a pressurized container with a high shear rate mixer. Said pressurized container does not necessarily have any structural difference from a pressurized vessel, but the term container is used for clarity. Said high shear rate mixer present within said pressurized container may comprise a motor driven impeller such as a propeller or a turbine rotor. In a preferred embodiment said impeller comprises a stator and a rotor. Typically said high shear rate may be obtained by maintaining the distance between the surface of the rotor to the surface of the stator below 5 mm, such as a distance below 2.5 mm, and preferably below 1 mm such as below 0.5 mm, and advantageously below 0.2 mm. The rotor part may be rotating at a relative high rotating speed so as to obtain a vigorous mixing and a high shear rate. Often said rotor may have a rotating speed of at least 5000 rpm, such as a speed of at least 10000 rpm, and preferably a speed of at least 15000 rpm such as at least 20000 rpm, and advantageously the rotor is rotating at a speed of 24000 rpm or more.

Furthermore the re-circulation loop may comprise ultrasonic generating means for generating ultrasonic waves or vibrational waves in/of said fluid being withdrawn to said re-circulation loop. The frequency of said ultrasonic generating means may be in range 20 khHx to 10 MHz, such as in the range 20 kHz to 2 MHz, and preferably in the range 20 kHz to 50 KHz such as the range 40-50 KHz. The ultrasonic generating means may comprise a piezoelectric or magneto-restrictive structure. In a number of preferred embodiments said ultrasonic generating means may be located within said pressurized container within said re-circulation loop.

In another preferred embodiment said mixing in said one or more mixing zones may be at least partly provided by atomizing said fluid being withdrawn to said re-circulation loop by spraying said fluid into said pressurized container in said re-circulation loop through one or more nozzles. In a particularly preferred embodiment said one or more nozzles may be ultrasonic nozzles. In alternative embodiments said one or more nozzles may comprise one or more membranes situated within said pressurized vessel with said re-circulation loop.

In a number of important embodiments of the present invention the pressurized vessel is agitated. The agitation may be provided by a motor driven mixer such as an impeller. The rotating speed of said impeller in said pressurized vessel is often relative low such as a rotating speed in the range 100-5000 rpm, such as a rotating speed of said impeller in the range 250-3000 rpm, and preferably in the range 500-2000 rpm.

The pressurized vessel may also comprise ultrasonic generating means and/or one or more atomizing nozzles such as one or more ultrasonic nozzles.

A particularly preferred embodiment according to the present invention comprises withdrawing from an agitated pressurized vessel at least part of a fluid or fluid mixture contained in said agitated pressurized vessel and feeding it to a re-circulation loop, said re-circulation loop comprising a pressurized container comprising a high shear rate mixer for promoting formation of micro emulsions, and subsequently feeding said fluid or fluid mixture back to said pressurized vessel.

In another preferred embodiment according to the present invention said pressurized vessel comprises a plurality of hollow tubular members, at least part of the walls of said hollow tubular members comprising membranes, the plurality of hollow tubular members defining interstices therebetween allowing for flow and
Contacting the outer surface of a plurality of hollow tubular members with a first fluid, and
Contacting a second fluid with the inner surface of said hollow tubular members, at least part of said second fluid is permeating said membrane walls forming a plurality of micro emulsion(s) of said second fluid dispersed in said first fluid.

In the present description with claims the term hollow tubular members comprise hollow fibres, and other hollow tubular bodies having any cross section, e.g. a hollow tubular chamber. Likewise the term the surface of a membrane and similar terms are intended to mean at least part of a membrane surface.

One preferred embodiment according to the present invention, comprises a plurality of hollow fibre membranes. Typically the hollow tubular members may be arranged into one or more section(s) or array(s) having a porous structure of any shape. Said one or more section(s) may further be arranged within a pressure housing such as a pressure vessel. Various ways of arranging such fibres are known in the prior art (e.g. W. S. Ho et al, “Membrane Handbook”, Van Nordstrand Reinhold, 1992, ISBN 0-442-23747-2, K. Scott, “Handbook of Industrial Membranes”, Elsevier Publicers, 1995, ISBN 1856172333, Iversen et al, WO95351153, Iversen et al, WO00160095, U.S. Pat. No. 690,830, U.S. Pat. No. 5,690,823) and are hereby included by reference. Such methods includes random packings, mats, cloths, bundles, twisted bundles, meshs, arrays etc.

The inner surface of said hollow tubular members generally have one end communicating with an inlet plenum for feeding said second fluid to the lumen side (inner surface) of said hollow tubular members, and the other end of said tubular members communicating with an outlet plenum for collection the remaining part of said second fluid after passage through the lumen of said hollow tubular members. Likewise, the pressure housing will generally comprise one or more inlets for introducing said first fluid and/or surfactants and one or more outlets for withdrawing said first fluid containing said emulsions formed.

In an aspect the present invention comprises a plurality of fibres extending in substantially the same direction. One way of packing such fibres relevant to the present invention is disclosed in U.S. Pat. No. 5,690,823 hereby included by reference.

In many embodiment according to the present invention the membrane is porous, and have pores in the range 0.001-100 micron, such as pores in the range 0.001-10 micron and preferably in the range 0.01-0.2 micron.

The hollow tubular member material may comprise a wide range of materials depending on the specific application. Nonlimiting examples of materials suitable for the present invention includes polymers from polypropylene, polyethylene, polystyrene, polyether polymers, polyamide, polyacrylic, polyimide, fluoropolymers, ceramics, and elastomers such as natural, synthetic and cured rubbers, and silicones (siloxane polymers).

The diameter of said water core in the emulsions formed may typically be in the range 0.001-30 times the diameter of the pores of the membrane part of said hollow tubular members, such as in the range 0.01-15 times the diameter of the pores of the membrane part of said hollow tubular members.

In most embodiments the pressure of the fluid(s) contacting the inner surface of said hollow tubular members is higher than the pressure of the first fluid. Typically the pressure difference between the fluid(s) contacting the inner surface of said hollow tubular members and the first fluid may be in the range 0.01-100 bars, such as in the range 0.1-50 bars, and preferably in the range 0.1-20 bars such as in the range 0.1-10 bars.

In many preferred embodiments according to the present invention the hollow tubular members constitute a large contact area within said pressurized vessel and said large contact area may be used to control the temperature profile within said pressurized vessel is controlled by controlling the temperature and flow rate of at least one fluid contacting the inner surface of said hollow tubular members.

A particular preferred embodiment said tubular members comprise two separate set of hollow tubular members, both sets of said hollow tubular members comprising an inlet and an outlet plenum communicating with the outside of said pressurized vessel, and wherein two separate fluids may be contacted with the inner surface of said hollow tubular members, and wherein two different emulsions of said fluids in said first fluid contacting the outer surface of said hollow tubular members are formed.

Many applications of the present invention involve expanding said first fluid containing said micro emulsion(s) is/are expanded in a device external to the pressurised vessel. Said expansion in said external device may be performed in a controlled manner within said vessel and/or it may be expanded through a nozzle into said external device by e.g. a RESS or RESOLV technique.

A number of important applications relates to deposition of the content of said micro emulsions formed on the surface of a substrate such as on the surface of solid material present in said external device.

According to the present invention said material being deposited may comprise an inorganic substance.

Furthermore said material being deposited may according to the present invention be a pharmaceutical substance such as a medical agent, a biologically active material, an antigen, an enzyme, a therapeutic protein or a therapeutic peptide.

Additionally said material being deposited may according to the present invention be a metal, a semi-metal, a metal oxide or a semi-metal oxide.

In an embodiment of the present invention said material being deposited comprises an electroceramic material.

In another embodiment according to the present invention said material being deposited material comprises a semi-conducting material.

A yet another embodiment said material being deposited comprises a magnetic, ferromagnetic, paramagnetic, or superparamagnetic material.

Advantageously the deposited material constitutes a layer of primary particles having an average diameter of the most 30 nm such as at the most 20 nm, such as an average diameter of at the most 10 nm.

In a preferred embodiment according to the present invention thickness of said deposited layer is at the most 500 nm, such as at the most 100 nm, and preferably at the most 50 nm such as at the most 25 nm.

In a further preferred embodiment the treated solid material comprises a tape cast for tape casting.

In a still further preferred embodiment said treated solid material comprises a catalyst material.

Advantageously, said treated solid material may according to the present invention comprise a ceramic membrane.

Additionally, said treated may according to the present invention comprise a fuel cell material.

Furthermore, said treated solid material may according to the present invention comprise a photolithographic lens or mask.

Still further, said treated solid material may according to the present invention comprise a medical and/or a pharmaceutical article.

An number of important applications according to the present invention may be related to fine particle products.

In one embodiment of the method said external device may be an apparatus for producing fine particles.

In another embodiment of the method one or more additional fluids containing micro emulsions with substances dissolved and/or dispersed therein, is introduced in to said external device, so as to perform a micro encapsulation of said fine particles formed.

Furthermore, the method according to the invention may further involve a solvent contained within said external device and said fine particles being collected as a dispersion or suspension of said fine particles within said solvent. Said solvent may further comprise a reactant for said particle formation process.

In a preferred embodiment said primary particles formed comprise one or more pharmaceutical and/or biological material(s).

In another preferred embodiment of the method said material being deposited and/or collected within said external device comprise one or more metal(s) or one or more semi-metal(s) or a combination thereof.

Furthermore, in a preferred embodiment the electrolyte dissolved and/or dispersed within said micro emulsions is/are a reactant(s) in a supercritical sol-gel reaction.

In yet another preferred embodiment according to the present invention said fine particles formed comprise oxide(s) such as metal oxide(s) or semi-metal oxide(s).

In an additional embodiment of the present invention, said oxides is/are a thermoelectric material or a precursor for production of a thermoelectric material.

In a further embodiment of the present invention said oxide(s) are an oxygen ion conducting oxide(s) such as Ce₁₋ₓGdₓO_{2-x/2}, LaGaO₃, or doped ZrO₂

In a still further embodiment said primary particles formed are carbide(s) and/or nitride(s) and/or sulphides and/or borides and/or hydrides and/or halogenides.

### DESCRIPTION OF THE DRAWINGS

The following abbreviations apply to the figures:
F: Fluid
F1: Fluid 1
F2: Fluid 2
S: Surfactant or Surfactants
ME: Micro emulsion

FIG. 1 is a generalized illustration of a preferred embodiment for production of micro emulsions of a second fluid in a first fluid in a method according to the present invention. A first fluid (F1), a second fluid (F2) and one or more surfactant(s) (S) are introduced into a pressurised vessel (1), and formation of micro emulsions is promoted. The first fluid (F1), the second fluid (F2) and said one or more surfactant(s) (S) may be introduced into said pressurised vessel in a number of positions so as to provide a specific flow regime within said pressurised vessel (1) e.g. the fluids may be introduced cocurrently, countercurrently, as a premixed fluid or as a partly pre-mixed fluid etc. Further said fluids may be introduced through a multitude of nozzles. Many applications of the present invention comprise withdrawing a fluid stream (F) comprising said micro emulsions (ME) of said second fluid (F2) dispersed in said first fluid (F1) in at least part time of said method. Said fluid stream (F+ME) is generally in a near critical or supercritical state. In a particularly preferred embodiment said fluid stream (F+ME) may be withdrawn in a substantially continuous manner.

FIG. 2 shows an example of a preferred embodiment for production of micro emulsions of a second fluid in a first fluid in a method according to the present invention. A first fluid (F1), a second fluid (F2) and one or more surfactant(s) (S) are introduced into a pressurised vessel (1), and formation of micro emulsions is promoted. The pressurised vessel (1) is agitated by an impeller (2) driven by the motor (3). The rotating speed of said impeller (2) may be in the range 500-2000 rpm. The pressurised vessel may further comprise ultrasonic means such as one or more ultrasonic nozzles and/or piezoelectric means and/or magneto-restrictive means (not shown on the figure). Part of the fluid or fluid mixture present within said pressurised vessel (1) is withdrawn to a re-circulation loop by the fluid pump or compressor (4) and fed to a heat exchanger (5) for control of temperature of said fluid or fluid mixture being withdrawn, and subsequently to the pressurised container (6). Said pressurised container (6) may comprise at least one mixing zone. The pressurised container (6) is agitated by the impeller (7) driven by the motor (8). The impeller (7) may comprise a rotor and a stator such as illustrated below in FIG. 3. The rotor of said impeller (7) will often rotate with a relatively high rotating speed such as a rotating speed of 20000 rpm or more so as to provide a high shear rate mixing for promotion of very small droplets of said second fluid (F2) emulsified in said first fluid (F1). Likewise the maximum distance between the surface of said rotor to the surface of said stator may be maintained relatively small such as in the range 0.2-0.5 mm, so as to provide a high shear rate and a very vigorous mixing. The pressurised container (6) may further comprise ultrasonic means such as one or more ultrasonic nozzles and/or piezoelectric means and/or magneto-restrictive means (not shown on the figure). After passage of the pressurised container (6), the fluid mixture comprising said micro emulsions of said second fluid (F2) in said first fluid (F1) is fed back to the pressureised vessel (1). A fluid stream (F+ME) comprising said micro emulsions in said first fluid may be withdrawn from said pressurised vessel (6).

FIG. 3 shows an example of a principle of a suitable impeller for use for promotion of formation of micro emulsions in an embodiment according to the present invention. As indicated on the drawing, and described above under FIG. 2, the rotor (1) may be rotating as indicated, and the distance between the outer surface of the rotor and the inner surface of the stator may be maintained relatively small so as to provide a high shear rate mixing. Both the rotor (1) and the stator (2) may comprise a multiplicity of openings such as holes or slits as indicated on the drawing. The fluid mixture flow into the centre of the impeller from the bottom and/or the top, and will be forced through the openings by the high shear rate mixing. Hereby said second fluid is “cut” into small droplets of said second fluid (F2) in said first fluid and forms micro emulsions (ME) as indicated on the drawing. Said micro emulsions (ME) are stabilised by the one or more surfactant(s) being introduced, and the specific density being applied (pressure and temperature). The size of said micro emulsions may be controlled by selecting a suitable combination of impeller design and operation, type and concentration of surfactant(s), and physical operating conditions such as pressure and temperature. Suitable impellers comprising a rotor and stator are commercially available from a number of suppliers, e.g. the Polytron® systems from the company Kinematica AG, Switzerland.

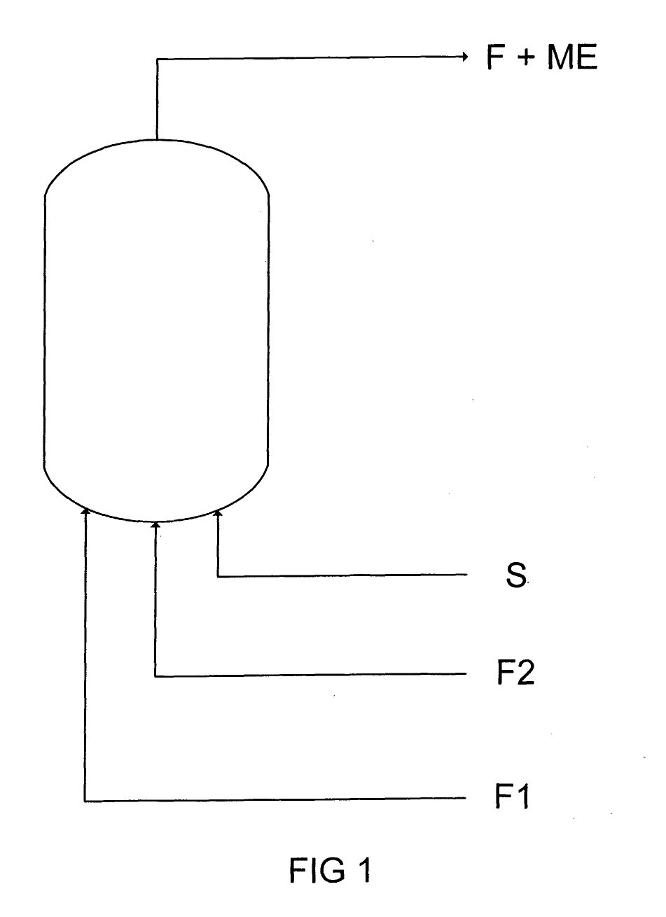

FIG. 4 shows an example of an embodiment, wherein a fluid stream (F+ME) comprising micro emulsions of said second fluid (F1) in said first fluid (F2) is withdrawn from a pressurised vessel similar to the one described under FIG. 1-3 above, and introduced into an external device (9) down stream said pressurised vessel (1). Said external device (9) may comprise a substrate such as a solid matrix to be treated. The fluid stream being withdrawn may be used as:
A versatile solvent for extraction of polar, ionic and/or non-polar non-volatile species from said substrate present in said external device (9).
A carrier for transporting compounds dissolved and/or dispersed in said micro emulsions such as deposition of said compounds being dissolved and/or dispersed in said micro emulsions on the surface of said substrate being present in said external device.
templates for producing nano-scaled primary particles.

The pressure in said external device is controlled by the control valve (10). It should be understood that the embodiment may include other means for controlling the various parts of the embodiment e.g. for decoupling the pressure control of said external device from the pressure control of the pressurised vessel (1) and the pressureised container (6). Such optional control means are not shown in the drawing. In the embodiment, wherein an extraction process is performed in said external device (9) the fluid stream (F) being withdrawn from said device may comprise said micro emulsions with extracted components. For such extraction applications the first fluid, second fluid, and extracted compounds may be separated by expansion in one or more separation step(s), and the fluid stream F3 may not be introduced into said external device (9). In many applications according to the present invention said treatment in said external device (9) comprises a deposition of said compounds being dissolved and/or dispersed in said micro emulsions in said fluid stream (F) on a substrate such as on the surface a solid matrix present within said external device (9). In such embodiments said deposition may be performed by expanding said fluid (F) so as to provide a collapse of said micro emulsions. Said expansion of said fluid may be performed by decreasing the pressure within said external device in a controlled manner by use of the control valve (10) after a pre-selected treatment time and/or said expansion may be performed by expanding said fluid (F) through a nozzle such as in the RESS technique. A third fluid stream (F3) may be introduced into said external device (9) after said expansion of said fluid (F). The purpose of introducing said third fluid stream (F3) may be to remove said second fluid and/or said surfactant(s) and/or to dry said substances being deposited on said surface of said substrate being treated within said external device. In other embodiments a fourth fluid stream (F4) may further be introduced. Said fourth fluid (F4) may comprise a fluid comprising micro emulsions e.g. micro emulsions of a different composition and/or may comprise one or more reactant(s) such as a reducing agent for reduction of said deposited substances on the surface of said material being treated. It should be understood that said external device (9) may communicate with several pressurised vessels operating according to a method of the present invention, and that the treatment may be repeated multiple times e.g. so as to produce a multilayered structure on the surface of said substrate.

In still further applications of the present invention said micro emulsions contained in said fluid stream (F) are used as templates for producing nano-scaled primary particles. For such embodiments said external device (9) may comprise a separation device, wherein said primary particles produced may be separated from said first fluid, second fluid and/or one or more surfactants. In applications, wherein a substantially dry product is desired said external separation device (9) may comprise a filter such as a bag filter or membrane filter. In other applications, wherein a product comprising said primary particles suspended in a liquid is produced, said external separation device may comprise a vessel containing said liquid for suspending said primary particles. Said liquid will in may such application act as an antisolvent. Many embodiments for production of both a substantially dry particle product and a product comprising said primary particles suspended in a liquid, involve expanding said fluid stream (F) prior to, and/or into and/or within said external separation device, e.g. through a nozzle like in the RESS and RESOLV techniques.

FIG. 5 shows an example of pressurised vessel according to an embodiment of the present invention. Said pressurised vessel comprises a plurality of hollow tubular members extending in substantially the same direction and communicating with both an inlet and an outlet plenum. The lumen side (internal surface) of said plurality of hollow tubular members may be sealed from the shell side (outer surface) by “potting” the hollow tubular members in both ends using a potting material. The potting of hollow tubular members may be carried out in any suitable manner and such procedures are well known in the art (e.g. U.S. Pat. No. 3,422,008, U.S. Pat. No. 3,339,341, U.S. Pat. No. 3,442,389, U.S. Pat. No. 3,455,460, U.S. Pat. No. 3,690,465, U.S. Pat. No. 4,207,192, U.S. Pat. No. 5,264,171, EP 0562520A1 etc.), all of which are incorporated by reference. The potting material may be organic or inorganic or a mixture thereof. Suitable potting materials are well known and described in U.S. Pat. No. 4,369,605 and U.S. Pat. No. 3,422,008 incorporated herein by reference. The plurality of hollow tubular members may be arranged in a pressurised vessel as shown in the FIG. 5a. The first fluid and surfactant(s) is typically introduced through an inlet port on the shell side of the hollow tubular members, and contacts the outer surface of said hollow tubular members during the passage between the interstices between the hollow tubular members in said hollow tubular member array as shown in the drawing. The second fluid is introduced into said inlet plenum and is distributed to the lumen side (inner surface) of said tubular member(s). At least part of said fluid permeating through the membrane walls of said tubular members so as to obtain a controlled addition of said second fluid and/or dissolved substances to said first fluid on the outer surface of said hollow tubular members. The hydrophilic part of the surfactant(s) combines with the micron- or nano-sized droplets of said second fluid formed at the outer surface of said membrane part of said hollow tubular members as illustrated in FIG. 5c-5d. The micro emulsions of said second fluid in said first fluid, which optionally contain substances dissolved and/or dispersed therein may be continuously withdrawn from the hollow tubular member containing pressurised vessel as indicated.

FIG. 6 shows an example of superimposed layers of hollow tubular members, where two different fluids (A and B) may be conducted through the lumen of the fibres, as indicated, whereas a flow of a third fluid may be passed transversely through the fibres from above, perpendicular to the longitudinal direction of the fibres, as indicated by the vertical arrow.

FIG. 7 illustrates a situation similar to the one in FIG. 6, but where a wowen array of hollow membrane fibres is used.

FIG. 8 shows an example of an array of hollow tubular members, wherein the hollow tubular members are constituted by elongated chambers arranged longitudinally substantially parallel to each other, the longitudinal surfaces of the chambers having at least one region, being constituted by at least one membrane. The horizontal arrow indicates the direction in which the first fluid moves and the two vertical arrows indicate the direction in which the second fluid moves. The membrane surfaces are not explicitly shown in the figure, but one or more membrane surface(s) may preferably be arranged on each of the sides parallel to the direction in which the first fluid moves. The enlarged section shows the chambers in which the first fluid moves. The enlarged section shows the chambers and the outlet plenum. In order to obtain a rigid array of chambers, especially where a large part of the individual chamber surface is constituted by a flexible flat membrane, the individual chambers or adjacent chambers may be supported by a supplementary structure. Thus in a preferred embodiment the chambers comprise a perforated-, porous, mesh- or net structure. The array of hollow tubular members is generally arranged in a pressurised vessel. This pressurised vessel may e.g. be part of a tubing or conduit for carrying said first fluid as illustrated in the drawing. It should be noticed that a multiplicity of such arrays may be superimposed in the direction of said first fluid and arranged in the same pressurised vessel. It should further be noticed that the hollow tubular member array(s) may have other kinds of cross section or be a segment of a cylindrical conduit such as described in WO9535153.

FIG. 9 shows an example of two pressurized vessels, wherein two different micro emulsions of said second fluid containing at least two different electrolytes dissolved therein is formed in two different streams of said first fluid containing two different surfactants. The two fluid streams containing said micro emulsions may be mixed and reacted in an external device e.g. a pressure vessel downstream of said pressurized vessels such as described above under FIG. 4. An important embodiment according to the present invention may be where said external pressurized vessel further comprises a solid matrix for deposition of said materials formed from reaction between said electrolytes contained in said micro emulsions formed. After a certain treatment time within said pressure vessel, the materials formed may be deposited on the surface of said solid matrix by breaking the emulsions by decreasing the density of said first fluid by a change in the pressure and/or the temperature of said first fluid or by a combination thereof.

Nonlimiting examples of where this invention may be applied is the in production heterogeneous catalysts, various kinds of ceramics e.g. ceramic membranes, fuel cells, solar cells, electronics, semiconductors, magnetic materials, thermoelectric materials, photographic materials, conducting polymers, medical articles, tape casts for tape casting of ceramics etc., wherein a thin layer of a nano-particulate material is desired.

### EXAMPLES

### Illustrative Example 1

In a preferred embodiment according to the present invention a near critical or a supercritical fluid comprising a micro emulsion of water-in-CO₂ may be continuously formed by introducing:
a stream of compressed CO₂ into a pressurized vessel
one or more surfactant(s) into said pressurized vessel
a stream of water or a water mixture comprising one or more substances dissolved and/or dispersed therein into said pressurized vessel
promoting formation of said water-in-CO₂ emulsions
   and withdrawing a fluid stream comprising said water-in-CO₂ emulsions from said pressurized vessel.

The pressurized vessel may in many embodiments according to the present invention be an agitated vessel operating at a substantially constant pressure, which may be in the range 50-500 bars, and preferably in the range 85-500 bars such as in the range 100-300 bars. The temperature within said vessel may be in the range 20-500° C., such as in the range 30-450° C., and preferably in the range 35-200° C., more preferably in the range 40-150° C.

Said promotion of water-in-CO₂ emulsions may be performed by withdrawing part of the fluid or fluid mixture present within said pressurized vessel to a re-circulation loop comprising one or more mixing zones for promotion of said formation said water-in-CO₂ emulsions. At least one of said mixing zones in such embodiments is typically positioned within a pressurized container, and is at least partly provided by a high shear rate mixer located within said pressurized container. It should be understood that said pressurized container do not necessarily have any structural difference from a pressurized vessel, but the word container is used for clarity.

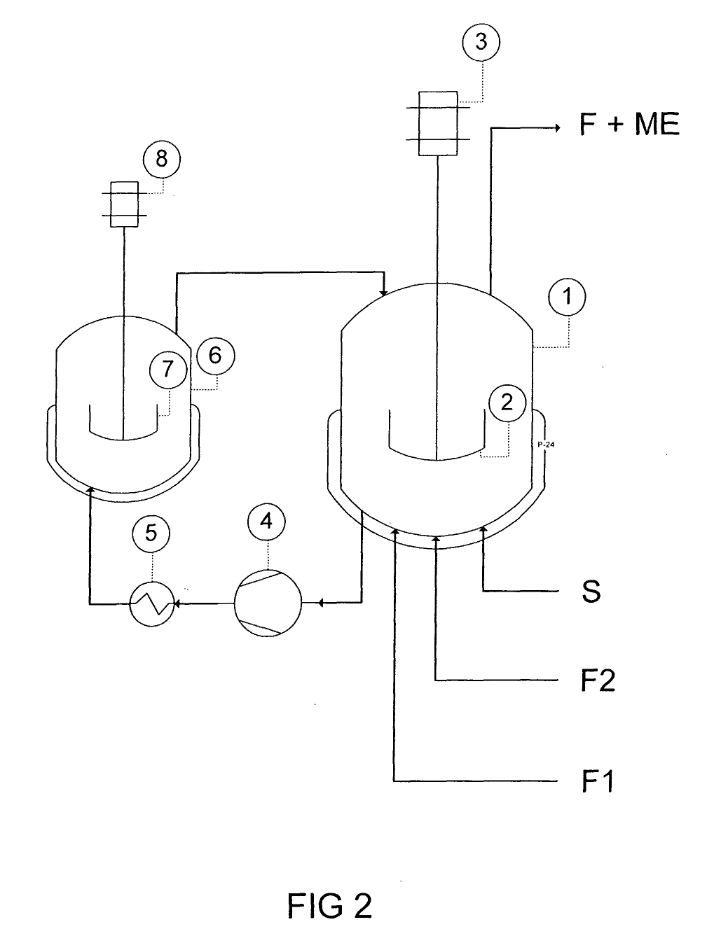

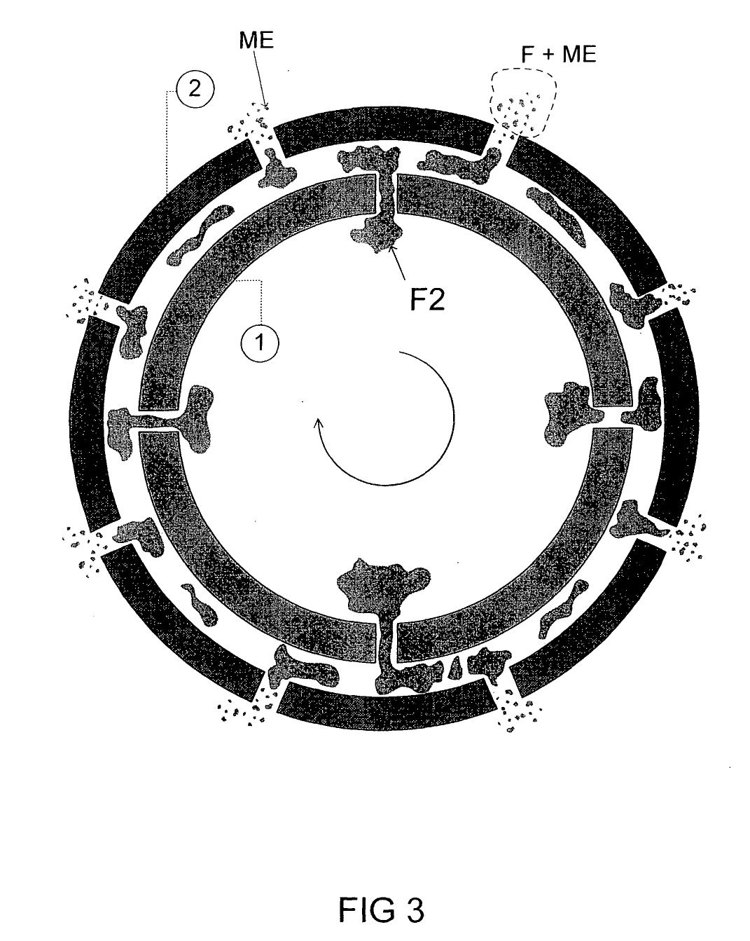

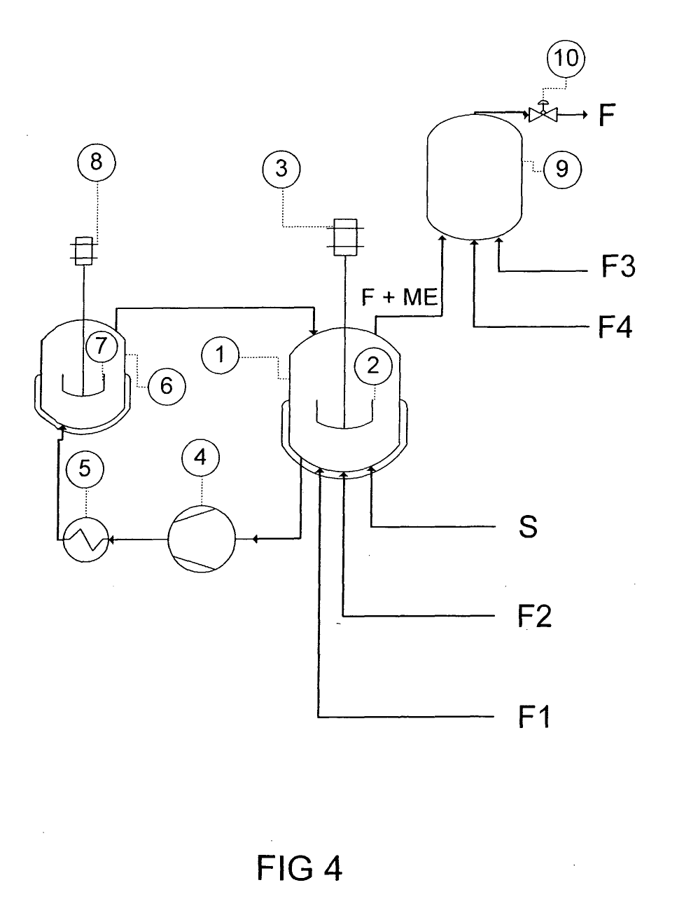

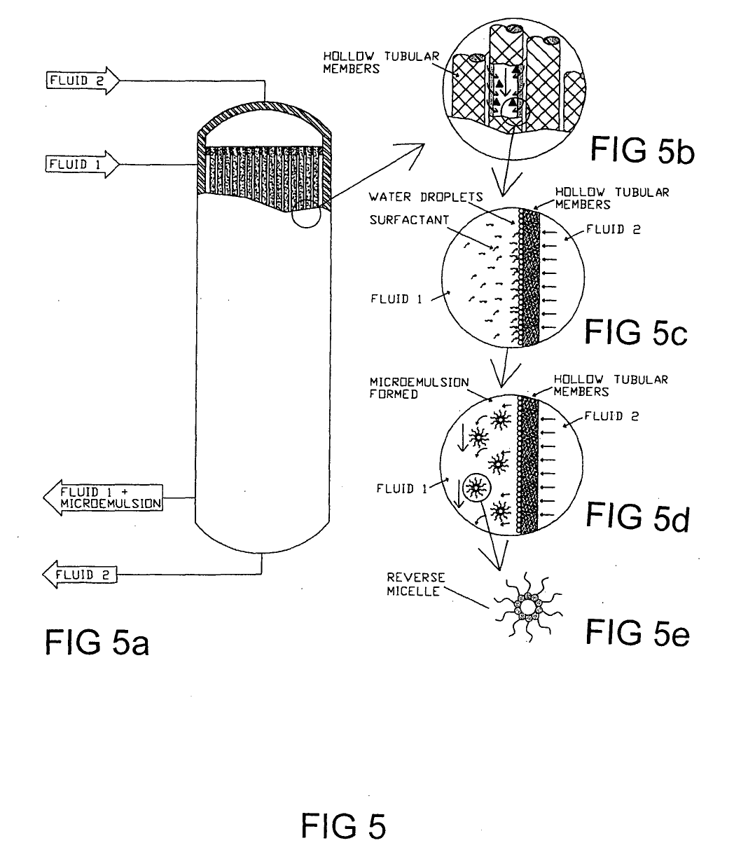

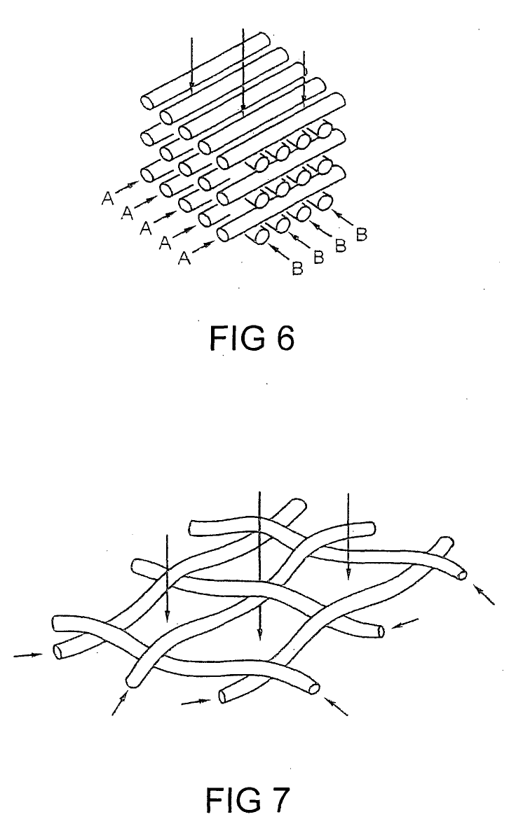

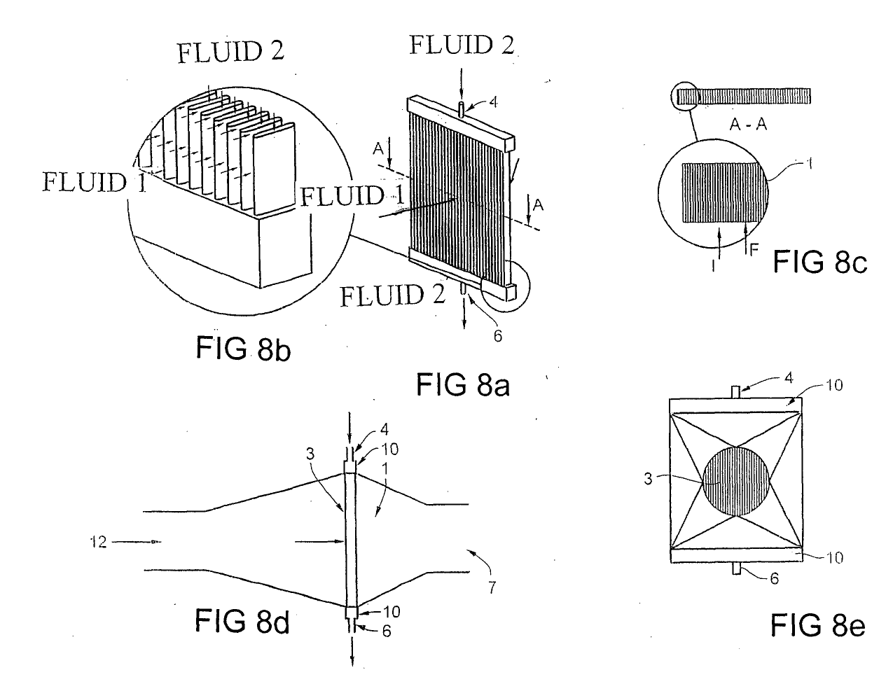

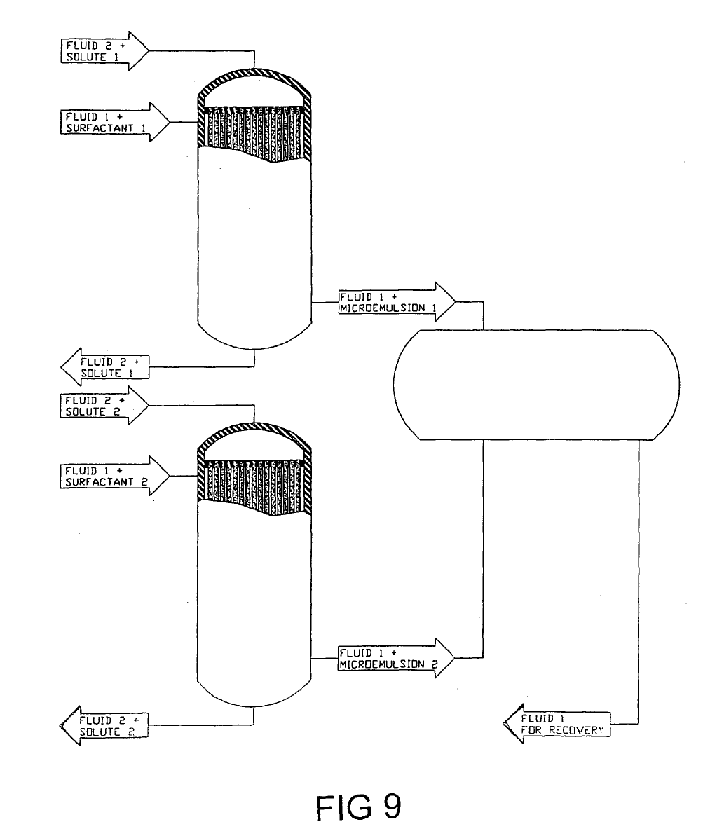

In many embodiments according the present invention said high shear rate mixing is preferably obtained by applying a rotor and stator impeller such as shown in the FIGS. 2-3 and described above. After passing said pressurized container the fluid stream comprising said water-in-CO₂ emulsions is fed back to said pressurized vessel.

The size of the water core of said emulsions being formed may be controlled by proper selection of impeller design, rotor speed, water to CO₂ concentration, type and concentration of said one or more surfactants being introduced, flow rate of the fluid stream being withdrawn from said pressurized vessel, and the operating pressure and temperature. Hence, micro emulsions of controllable size may be produced in such embodiments.

### Illustrative Example 2

In another preferred embodiment of the present invention a micro emulsion of water-in-CO₂ may be continuously formed in a pressurized vessel comprising a plurality of hollow tubular members by introducing:
a compressed CO₂ stream to an inlet plenum for the first fluid and thereby contacting the outer surface of a plurality of hollow tubular members with said first fluid.
one or more surfactant(s) to the first fluid by premixing the compressed CO₂ stream with the surfactant, or introducing the surfactant to the same inlet plenum as for said first fluid, or through a separate inlet point, and thereby contacting said outer surface of said plurality of hollow tubular members with a compressed CO₂ fluid containing said surfactant(s).
a compressed water stream to the inlet plenum for the second fluid and thereby contacting said second fluid with the inner surface of said plurality of hollow tubular members.

Part of the water phase contacting said inner surface of said hollow tubular members permeates through the membrane part of said hollow tubular members, and thereby a nano- or microatomization occurs, and may result in very small droplets being formed at the outer surface of said hollow tubular members, and hence resulting in the formation of micro emulsions of water-in-CO₂ at the outer surface.

The membrane characteristics have an impact of diameter of the water core in the emulsions formed, and in general the diameter of the water core may be in the range 0.001-30 times the diameter of membrane pores at the outer surface, and may preferably be in the range 0.01-15 times the diameter of membrane pores at the outer surface.

The amount and size of the emulsions may further be controlled by controlling the pressure, temperature and flow rate of both the fluids as well as by controlling surfactant concentration.

In general the flux of water through said membrane may be controlled by maintaining a higher pressure of the second fluid than of the first fluid, thereby creating a pressure differential over said membrane. According to the present invention the pressure differential may be maintained in the range 0.01-100 bars, and preferably in the range 0.1-30 bars depending on the specific application.

The pressure and temperature of the first fluid depends on the specific application. In general the pressure of the first fluid may be maintained in the range 50-500 bars, preferably in the range 85-500 bars, such as in the range 100-300 bars. The temperature within the vessel is generally maintained within the range 20-500° C., such as in the range 30-450° C., and preferably in the range 35-150° C., such as in the range 40-100° C.

The compressed CO₂-phase containing said micro emulsions formed may be continuously withdrawn from the outlet plenum for said first fluid, and is e.g. suitable as a versatile solvent for extraction of polar, ionic and/or non-polar non-volatile species in a device external to the micro emulsion producing device.

Non-limiting examples of applications for use of said solvent includes extraction or dissolution of proteins and polypeptides, metal compounds, and processes for cleaning of textiles, metal and semiconductor parts etc.

### Illustrative Example 3

The hollow tubular member containing device described in illustrative example 2, generally constitute a large contact area between said first fluid and said second fluid.

In many applications according to the present invention this large contact area between the fluids may be used to control the temperature within the hollow tubular member containing device.

This may be performed by controlling the flow rate and inlet temperature of said second fluid, and withdrawing the remaining part from said outlet plenum for said second fluid to a an external re-circulation loop, wherein heat is added and/or extracted in the re-circulation loop and feeding the fluid back to the inlet plenum for said second fluid.

Thereby the temperature of both the first and the second fluid may be accurately controlled within the hollow tubular member containing pressure vessel.

### Illustrative Example 4

The fluid volume being withdrawn from said pressurized vessel to said re-circulation loop described in illustrative example 1, may often be relatively high. The fluid volume being withdrawn may correspond to exchange of at least 0.1 fluid volume within said pressurized vessel per minute, such as at least 0.25 fluid volume exchanges per minute, preferably the fluid volume being withdrawn corresponds to at least 0.5 fluid volume exchanges within said pressurized vessel per minute, and even more preferable the fluid volume being withdrawn from said pressurized vessel corresponds to at least 1 volume exchanges per minute, and advantageously the fluid volume being withdrawn from pressurized vessel corresponds to exchange of at least 2 vessel volumes per minute such as exchange of at least 5 vessel volumes per minute.

Hence, many embodiments according to the present comprises the step of controlling the temperature within said pressurized vessel by controlling the temperature within said re-circulation loop.

### Illustrative Example 5

Many applications according to the present invention involve continuous production of micro emulsions of water-in-CO₂, wherein the water core of said micro emulsions contains dissolved and/or dispersed substances such as electrolytes dissolved and/or dispersed therein.

In such applications the compressed water stream described in the illustrative examples 1 and 2 may contain such dissolved and/or dispersed species in a pre-selected concentration.

In embodiments wherein said pressurized vessel comprises hollow tubular members, the membrane characteristics and pressure differential over said membrane may be adapted to control the concentration of said species in the micro emulsions formed in a predefined manner.

The compressed CO₂-stream containing said micro emulsions with dissolved and/or dispersed substances therein, may be continuously withdrawn from said pressurized vessel.

In a preferred embodiment said compressed CO₂-stream comprising said water-in-CO₂ emulsions may be used as a carrier for transporting said dissolved and/or dispersed species into an external device, e.g. a coating or impregnation vessel containing a solid material to be coated with said dissolved and/or dispersed species. After a certain treatment time said dissolved and/or dispersed species is deposited on the surface of said solid material, by decreasing the density of said compressed CO₂ stream. This decrease in density may be performed by reducing the pressure and/or the temperature in the vessel containing said solid material or by a combination thereof.

Non-limiting examples of coating applications for use of said compressed CO₂ stream containing micro emulsions with substances dissolved or dispersed therein include deposition of metal compounds in production of electronics, catalysts, medical devices, polymers such as conducting polymers etc.

### Illustrative Example 6

Many biological and pharmaceutical materials are hydrophilic as they derive from living cells and are readily soluble in water and virtually insoluble in organic solvents and also possess a low solubility in dense phase CO₂. Examples of such classes of compounds include proteins, peptides, nucleic acids and pharmaceutical excipients such as carbohydrates and sugars, fillers and biologicals. Dissolution of such materials in organic solvents and/or exposure to heat and/or air often causes denaturation of such materials, thereby reducing the bioactivity of such materials.

The crystallinity is another very important issue in the pharmaceutical industry not only affecting drug stability but also affecting its dissolution rate. An amorphous form shows faster dissolution than the crystalline form of a given material. It is therefore desirable to control the crystallinity during material processing. Small amounts of water may increase the crystallinity (desirable in many applications).

Processing of such classes of compounds may be important in relation to the present invention. Such materials may be processed in the same way as described in the pre-vious examples. The material(s) in question may be dissolved or dispersed in a compressed aqueous stream, and atomized through said membrane(s) to form micro emulsions of water-in-CO₂.

Suitable surfactants for use in such systems may include a hydrophilic sugar group and a double tail of CO₂-philic molecules such as PDMS, fluoroalkyls, fluoroethers or others.

The compressed CO₂ stream containing said micro emulsions formed may be used as a carrier to transport said micro emulsions to an external device, e.g. a vessel containing a solid material for deposition of said dissolved species or to a particle formation device. An example of an application, wherein a deposition is involved may be for production of biocatalysts by deposition of enzymes on a polymeric matrix. Another important embodiment may be the use micro emulsions formed in processes for production of fine particles such as particles in the nano- or micrometer range as further exemplified below.

### Illustrative Example 7

In one embodiment according to the present invention two or more emulsions are formed in the same pressurized vessel by applying two or more separate sets of hollow fibres. All sets of hollow fibres comprising an inlet and an outlet plenum communicating with the outside of said hollow tubular member containing device, and wherein two or more separate fluids may be contacted with the inner surface of said hollow tubular members, thereby producing two or more different emulsions of said fluids in the first fluid contacting the outer surface of said hollow tubular members.

In an alternative embodiment production of two or more emulsions containing different dissolved species is performed in separate pressurized vessels e.g. according to the embodiments exemplified in the illustrative examples 1-2, and the fluid streams comprising said micro emulsions produced in said pressurized vessels may be combined in an external device, as illustrated in FIG. 9.

Upon combination of the micro-emulsion containing fluids in the external device, inter-micellar contact or combination of micelles containing different solutes may lead to chemical reactions in the micelle cavities. The second fluids comprising said the cores of said emulsions, should preferably be compatible, and preferably the same fluids, so as to allow contact between the emulsions.

Combination of, or contact between, the different emulsions produced in said separate pressurized vessels, and containing said dissolved reactants, may be enhanced by designing the surfactants used in the emulsion formation to facilitate contact between micelles of different content. The facilitation of contact between micelles of different content may be achieved by introducing an electrostatic force, induced by including a molecular charge displacement in the lipophilic part of the surfactant, and thereby creating a polarity in the molecule, with an electrically charged part of the molecule facing the continuous phase, i.e. the bulk of the first fluid. The electrical charge may cause attraction of surfactants with opposite charge, and repulsion of surfactants with identical charge. Introducing such polarity of opposite charges in the lipophilic part of the surfactants used to produce two micro-emulsions may facilitate contact between micelles containing different solutes, while reducing merging of micelles of the same solute content. Nonlimiting examples of organic molecular groups introducing polarity are halogenated alkyls or aryls, aldehydes, ketones, ethers, hetero-cyclic structures containing oxygen, nitrogen or sulphur, amines, amides or mercaptanes.

In both cases the exchange between the different micellar cavities may be enhanced by applying a pulsation effect, and/or an ultrasound effect and/or an vibrating surface effect in the device, wherein said exchange between different micellar cavities occurs. The pulsation effect may be performed by modulating the density of said first fluid containing said emulsions between an uppermost and a lowermost level. This density modulation may be performed by modulating the pressure and/or the temperature. Typically the density change between the uppermost and lowermost density level is up 75%, such as up to 50%, and preferable up to 30% and the density modulation may be repeated multiple times such as 5-100 times.

### Illustrative Example 8

An important micro emulsion system according to the present invention may be the use of the micro emulsions as templates for the syntheses of particles. Many such systems involve intermicellar exchange of different dissolved and/or dispersed substances. When such micelles collides mixing and reaction between such reactants contained in the different micellar cavities is facilitated.

An example of such system may a reverse micelle containing a metal salt dissolved in the water core and sulfide ions in the water core of another micelle. Intermicellar exchange results in the formation of metal sulfide nanoparticles within the nanoscale reverse micelle cavities. Particle growth stops due to the limitation of the particle size that the micelle can support, and the particle size may be controlled by changing the CO₂ solvent properties.

In another preferred embodiment a compressed water stream containing said metal containing substances dissolved or dispersed therein, is introduced into said pressureized vessel, and a fluid stream comprising said micro emulsions with said dissolved or dispersed in the water core is withdrawn to an external device, wherein said fluid comprising said micro emulsions contact with third fluid comprising a reducing agent such as an alcohol, hydrazine, hydrides, alkalides, Grignard reagents etc. is promoted. Said reducing agent may be contained within a micro emulsion contained in said third fluid. Contact between micelles containing the metal and the reducing agent may lead to formation of metal nano-particles. The formed metal nanoparticles may be harvested by expansion of the first fluid, and collection in conventional devices for particle collection, or might be deposited directly on a substrate, as a surface treatment of said substrate to form the final product.

### Illustrative Example 9

The emulsion formation techniques described in any of the previous examples may suitably be combined with any of the prior art particle formation processes using dense phase fluids, e.g. RESS (rapid expansion of supercritical solution), RESOLV (rapid expansion into a liquid solvent), SAS (solvent anti solvent), SEDS (solution enhanced dispersion by supercritical fluid), PCA (precipitation with compressed antisolvent) and variations thereof.

### Illustrative Example 10

A preferred embodiment according to the present invention is the formation of fine particles with subsequent deposition in a thin layer on a solid material comprising the end product. Nonlimiting examples of such applications is ceramic membranes, fuel cells, solar cells, semiconductors, self cleaning mirrors, conducting polymers, catalysts etc.

Another class of applications of a method according to the present invention is within life sciences, e.g. deposition of one or more drugs and/or bio-molecules on the surface of a polymer matrix, so as to obtain new functionalities such as controlled release, targeted release etc. in medical and/or pharmaceutical articles.

Still another class of applications of a method according to the present invention, is the deposition of antimicrobial compounds on the surface of polymers used as medical articles used in relation to surgeries and/or as in-body devices such as implants.

An additional advantage of the present invention in relation to the latter two applications may be that the processing may be performed under sterile conditions as high pressure CO₂ in itself exhibits sterilisation properties, and the final product may be processed so as to maintain a positive pressure of CO₂ within the article until packaging, thereby minimising the risk of cross contamination. By maintaining a positive pressure of CO₂ within the article produced until packaging the article will also be maintained within an inert atmosphere after packaging.

### Illustrative Example 11

There are several reasons for employing drugs as fine powders in pharmaceuticals, such as the need to improve the bioavailability of the drug or the requirement for specific pharmaceutical forms (nasal, opthalmic, injectables, modified release etc.).

As described in illustrative example 6, one of main the problems related to processing of biomolecules such as peptides and proteins e.g. enzymes etc., is that they easily loose bioactivity in contact with the organic solvent typically employed for supercritical processing of such biomolecules due to denaturation of the steric composition and they may further change crystallinity in the absence of water.

A new supercritical emulsion drying technique for preparation of inhalable protein particles was disclosed by J. Jung et al. at the 6th International Symposium on Supercritical Fluids in Versailles (France), Apr. 28-30, 2003 (J. Jung, F. Leboeuf, and M. Perrut, “Preparation of inhable protein particles by SCF Emulsion Drying”, In Proc. of 6^{th} International Symposium on Supercritical Fluids, Tome 3: Materials Processing, p. 1837-1842, 2003, ISBN 2-905-267-37-02, and M. Perrut et al, FR0106403), hereby included herein by reference.

In this technique, water-in-oil emulsion droplets containing dissolved proteins such as trypsin, catalase, lactase and insuline etc. was sprayed into a continuous feed of high pressure carbon dioxide. Protein particles precipitated as micron sized particles as a result of expansion of the droplets and removal of water by the CO₂ organic solvent mixture. The micron size particles showed a significantly higher preservation of bioactivity than for usual supercritical processing.

The method according to the present invention is suitable for continuous production of such water-in-oil emulsions containing dissolved and/or dispersed substances from a wide range of materials. Said micro emulsions may be further processed according to any supercritical method such as the one described above or in illustrative example 9.

1. A method for producing micro emulsions dissolved or dispersed in a compressed fluid in a supercritical state comprising:
introducing a first fluid into a pressurised vessel;
introducing one or more surfactant/-s into said pressurised vessel;
introducing a second fluid into said pressurised vessel;
promoting formation of micro emulsions of said second fluid within said first fluid present in said pressurised vessel;
wherein one of the fluids is water or contains water, and
wherein said water or water mixture further contains one or more substances being dissolved therein.

2-107. (canceled)

108. A method for producing micro or nano emulsions dissolved or dispersed in a compressed fluid in a near critical or a supercritical state comprising:
introducing a first fluid into a pressurised vessel;
introducing one or more surfactant(s) into said pressurised vessel;
introducing a second fluid into said pressurised vessel;
promoting formation of micro or nano emulsions of said second fluid within said first fluid present in said pressurised vessel;
wherein
the compressed fluid is CO₂
one of the fluids is water or contains water,
the diameter of the core(s) of said micro or nano emulsion(s) is/are at least partly controlled by controlling the density of said fluid(s) present within said pressurised vessel and,
said micro or nano emulsion(s) formed comprises a water core(s).

109. A method according to claim 108, wherein said water or water mixture further contains one or more substances being dissolved therein.

110. A method according to claim 108, wherein said micro emulsion(s) formed is continuously withdrawn from said pressurised vessel.

111. A method according to claim 108, wherein said pressurised vessel is an agitated vessel, and wherein said agitation is provided by a motor driven mixer such as an impeller, said impeller is rotating with a speed in the range 100-5000 rpm, such as an impeller with a rotating speed in the range 250-3000 rpm, and preferably in the range 500-2000 rpm.

112. A method according to claim 108, comprising re-circulating in at least part time of the method at least part of a fluid or fluid mixture present in said pressurised vessel, the re-circulating comprising withdrawing from the vessel at least part of a fluid contained in said vessel and feeding it to a re-circulation loop and subsequently feeding it back to said pressurised vessel, the method further comprising the step of controlling the temperature of the fluid in the re-circulation loop, wherein the fluid volume being withdrawn from said vessel to said re-circulation loop corresponds to exchange of at least 0.1 vessel volume per minute such as at least 0.25 vessel volumes per minute, preferably the fluid volume corresponds to exchange of least 0.5 vessel volumes per minute, and even more preferably exchange of at least 1 vessel volume per minute and advantageously the fluid volume being withdrawn corresponds to exchange of at least 2 vessel volumes per minute such as exchange of at least 5 vessel volumes per minute, and wherein said re-circulation loop comprises at least one mixing zone for promoting formation of micro emulsion(s).

113. A method according to claim 112, wherein said mixing zone(s) in said re-circulation loop comprise(s) a static mixer.

114. A method according to claim 112, wherein said mixing zone(s) in said re-circulation loop comprises a pressurised container with a high shear rate mixer, and wherein said high shear rate mixer comprises a motor driven mixer such as an impeller such as a propeller or turbine rotor.

115. A method according to claim 114, wherein said impeller comprises a stator and a rotor, wherein said high shear rate mixing is obtained by maintaining the distance from the surface of rotor to the surface of the stator below 5 mm, such as a distance of below 2.5 mm, and preferably below 1 mm such as below 0.5 mm, and advantageously below 0.2 mm, and wherein said high shear rate mixer in said pressurised container in said re-circulation loop comprises a rotor rotating with a speed of at least 5000 rpm such as a speed of at least 10000 rpm, and preferably at a speed of at least 15000 rpm such as a speed of at least 20000 rpm, and advantageously the rotor is rotating at a speed of 24000 rpm or more.

116. A method according to claim 112, wherein said re-circulation loop comprises ultrasonic generating means for generating ultrasonic waves or vibration waves in said fluid being withdrawn to said recirculation loop, wherein the frequency of said ultrasonic generating means are in the range 20 kHz to 10 MHz such as in the range 20 kHZ to 2 MHz and preferably in the range 20 kHz to 50 kHz such as in the range 40-50 kHz, and wherein said ultrasonic generating means comprises a piezoelectric or magneto-restrictive structure.

117. A method according to claim 116, wherein said ultrasonic generating means are placed within said pressurised container within said re-circulation loop.

118. A method according to claim 112, wherein said mixing in said one or more mixing zone(s) for promoting formation of said micro emulsions is at least partly provided by atomizing said fluid being withdrawn to said re-circulation loop by spraying said fluid into said pressurised container in said re-circulation loop through one or more nozzles.

119. A method according to claim 118, wherein said one or more nozzles comprise(s) one or more membranes situated within said pressurised container within said re-circulation loop.

120. A method according to claim 112 comprising withdrawing from an agitated pressurised vessel at least part of a fluid or a fluid mixture contained in said agitated pressurised vessel and feeding it to a re-circulation loop, said re-circulation loop comprising a pressurised
container comprising a high shear rate mixer for promoting formation of micro emulsions, and subsequently feeding said fluid or fluid mixture back to said pressurised vessel.

121. A method according to claim 120, wherein said second fluid and/or said surfactant(s) are introduced into said pressurised container in said re-circulation loop.

122. A method according to claim 121, wherein said second fluid and/or said surfactant(s) are premixed prior to introduction into said pressurised container.

123. A method according to claim 108, further comprising withdrawing in at least part time of said method a fluid stream comprising said micro emulsions suspended, dispersed or dissolved in said fluid in a supercritical state.

124. A method according to claim 114, wherein said one or more substances comprises polar molecules and/or polarizable molecules and/or non-polar, non-volatile molecules.

125. A method according to claim 116, wherein said one or more substances is substantially insoluble in said compressed CO₂.

126. A method according to claim 108, wherein said CO₂ containing fluid further comprises at least one co-solvent.

127. A method according to claim 126, wherein the co-solvent is selected from the group consisting of alcohol, water, ethane, ethylene, propane, butane, sulfurhexafluoride, nitrous oxide, chlorotrifluoromethane, monofluoromethane, methanol, ethanol, DMSO, isopropanol, acetone, THF, acetic acid, ethyleneglycol, polyethyleneglycol, N,N-dimethylaniline, and mixtures thereof.

128. A method according to claim 108, wherein said CO₂ containing fluid further comprises one or more surfactant(s), comprising a CO₂-philic portion and a CO₂-phobic portion.

129. A method according to claim 128, wherein said surfactant(s) is/are chelate(s) and/or fluorinated surfactant(s), and/or perfluoropolyether surfactant(s), and/or fluoroetherfluoracrylate surfactant(s) and/or siloxane surfactant(s).

130. A method according to claim 128, wherein said surfactant(s) is/are selected from the group consisting of hydrocarbons and fluorocarbons preferably having a hydrophilic/lipophilic balance value of less than 15, where the HLB value is determined according to the following formula: HLB=7+sum(hydrophilic group numbers)−sum(lipophilic group numbers).

131. A method according to claim 128, wherein the amount of said surfactant(s) compared to the amount of water corresponds to a concentration in the range 0.01 to 10 weight %, such as a concentration in the range 0.05 to 5 weight %, preferably a concentration in the range 0.1 to 3 weight %, and advantageously a concentration in the range 0.5 to 2 weight %.

132. A method according to claim 128, wherein the molar ratio of water to said surfactant(s) is at least 5:1, such as a molar ratio of at least 10:1, preferably a molar ratio of at least 20:1, such as a molar ratio of at least 30:1, and advantageously a molar ratio of at least 50:1 such as at least 100:1.

133. A method according to claim 128, wherein the molar ratio of compressed surfactant to the dissolved and/or dispersed molecules in said second fluid is at the most 100:1, such as at the most 50:1, and preferably at the most 30:1 such as at the most 10:1.

134. A method according to claim 108, wherein the pressure of at least one of said fluids is in the range 50-500 bars, preferably in the range 85-500 bars, such as in the range 100-300 bars.

135. A method according to claim 108, wherein the temperature in said pressurised vessel is maintained in the range of 20-500° C., such as 30-450° C., and preferably in the range of 35-200° C., and more preferably in the range of 40-150° C.

136. A method according to claim 108, wherein said pressurised vessel is operating at a substantially constant pressure.

137. A method according to claim 108, wherein said micro emulsion(s) containing fluid being withdrawn from said pressurised vessel is used to dissolve and/or extract substances from a material in a device outside of said pressurised vessel.

138. A method according to claim 108, wherein said water core comprises dissolved and/or dispersed substances and said fluid(s) containing said micro emulsion(s) is/are used as carrier(s) for transporting dissolved and/or dispersed species to an external device.

139. A method according to claim 108, wherein two or more micro emulsions of different compositions are produced in separate pressurised vessels and the fluids containing said micro emulsions are combined in an external device.

140. A method according to claim 139, wherein said two emulsions of different composition are formed using at least two different surfactants.

141. A method according to claim 140, wherein said surfactants are designed with electrostatic forces so as to facilitate contact of micelles of different types and to reduce merging of micelles of the same type.

142. A method according to claim 141, wherein said electrostatic forces are introduced by including a molecular charge displacement in the lipophilic part of the surfactant.

143. A method according to claim 142, wherein said molecular charge displacement are obtained by introducing polarity from organic molecular groups selected from halogenated alkyls and/or halogenated aryls and/or aldehydes, and/or ketones and/or ethers and/or hetero-cyclic structures containing oxygen, nitrogen and/or sulphur and/or amides and/or mercaptanes.

144. A method according to claim 108, wherein said micro emulsion(s) is/are used as nanoreactors for synthesis of nanoparticle materials.

145. A method according to claim 144, wherein at least one chemical reaction is occurring in said micro emulsions.

146. A method according to claim 144, wherein said micro emulsion(s) is/are used as template(s) for controlling said particulate material into a specific shape, size and/or structure.

147. A method according to claim 139, wherein the average size of said nanoparticle material formed is maximum 5000 nm, such as an average size of maximum 500 nm, preferably the average size is maximum 100 nm, and most preferably the average size is maximum 30 nm, such as maximum 15 nm.

148. A method according to claim 139, wherein the average size of said nano particle material formed is in the range 0.1-30 nm, such as in the range 1-10 nm.

149. A method according to claim 144, wherein said synthesis of said nanomaterials is at least partly controlled by controlling the temperature and/or the pressure of the fluid(s) during said synthesis.

150. A method according to claim 119, wherein said one or more membranes comprises the inner wall of said pressurised container within said re-circulation loop.

151. A method according to claim 150, wherein said pressurised vessel comprises ultrasonic generating means.

152. A method according to claim 151, wherein said pressurised vessel further comprises one or more atomising nozzles.

153. A method according to claim 152, wherein said atomising nozzles comprise at least one ultrasonic nozzle.

154. A method according to claim 108, wherein said pressurised vessel comprises a plurality of hollow tubular members, at least part of the walls of said hollow tubular members comprising membranes, the plurality of hollow tubular members defining interstices therebetween allowing for flow and
Contacting the outer surface of a plurality of said hollow tubular members with a first fluid, and
Contacting a second fluid with the inner surface of said hollow tubular members, at least part of said second fluid is permeating said membrane walls forming a plurality of emulsion(s) of said second fluid dispersed in said first fluid.

155. A method according to claim 154, wherein
the membrane part of said hollow tubular members comprises porous membranes,
the pore size of said porous membranes is in the range 0.001-100 microns, such as a pore size in the range 0.01-10 micron, and preferably having pores in the range 0.01-0.2 micron,
the diameter of said water core in the emulsions formed is in the range 0.001-30 times the diameter of the pores of the membrane part of said hollow tubular members, such as in the range 0.01-15 times the diameter of the pores of the membrane part of said hollow tubular members, and preferably in the range 0.1-10 times the diameter of the pores of said hollow tubular members, and
the pressure of the fluid(s) contacting the inner surface of said hollow tubular members is higher than the pressure of the first fluid,
the pressure differences between the fluid(s) contacting the inner surface of said hollow tubular members and the first fluid is in the range 0.1-100 bars, such as in the range 0.1-50 bars, and preferably in the range 0.1-20 bars such as in the range 0.1-10 bars.

156. A method according to claim 154, wherein said hollow tubular members comprise hollow fibres.

157. A method according to claim 154, wherein said membrane is a ceramic or polymeric membrane.

158. A method according to claim 154, wherein the temperature profile within said pressurized vessel is controlled by controlling the temperature and flow rate of at least one fluid contacting the inner surface of said hollow tubular members.

159. A method according to claim 154, wherein said tubular members comprise two separate sets of hollow tubular members, both sets of said hollow tubular members comprising an inlet and an outlet plenum communicating with the outside of said pressurized vessel, and wherein two separate fluids may be contacted with the inner surface of said hollow tubular members, and wherein two different emulsions of said fluids in said first fluid contacting the outer surface of said hollow tubular members are formed.

160. A method according to claim 108, wherein the first fluid containing said micro emulsion(s) is expanded in a device external to the pressurised vessel.

161. A method according to claim 160, wherein the first fluid is rapidly expanded through one or more nozzles using a RESS or a RESOLV technique.

162. A method according to claim 160, wherein the content of said micro emulsions formed is deposited on the surface of a substrate such as on the surface of solid material.

163. A method according to claim 138, wherein said external device is a device for producing fine particles and contains a solvent and said fine particles are collected as a dispersion of said fine particles within said solvent.

164. An apparatus comprising means according to claim 108 being adapted to carry out the method according to claim 108.
